(19) United States
(12) Patent Application Publication
(10) Pub. No.: US 2005/0068612 A1
(43) Pub. Date: Mar. 31, 2005

(54) Pre-programmable optical filtering / amplifying method and apparatus

(76) Inventors: Gordon Wilson, San Francisco, CA (US); Joseph E. Ford, Del Mar, CA (US); Cabatic Sherwin, Santa Clara, CA (US)

Correspondence Address: Jeffery J. Brosemer, Ph.D., ESQ., 138 S. Telegraph Hill Road, Holmdel, NJ, 07733, US

(21) Appl. No.: 10/674,563

(22) Filed: Sep. 30, 2003

(51) Int. Cl. H01S 3/00

(52) U.S. Cl. 359/337

(57) ABSTRACT

An optical amplification method which includes a spectral filtering method for selecting one of several pre-recorded spectral filter patterns and applies this filter to the spectral distribution of a multi-wavelength optical signal transmitted from an input to an output fiber. Optical filtering may be accomplished using free-space bulk optical diffractive wavelength demultiplexing, combined with a fixed (permanent) spatial pattern located in the spectrally dispersed image plane, to transfer to the optical output fiber the input signal with its spectrum selectively attenuated.

### BACKGROUND OF THE INVENTION

1. Field of the Invention

This invention relates generally to the field of optical communications and in particular to wavelength division multiplexed (WDM) fiber optic communications, where multiple independent optical signals are carried on the same single mode optical fiber for long distance transmission. More specifically, it pertains to dynamic spectral filtering of WDM signals used to maintain the desired relative intensities of the multiple signals as they are carried through an optical communications network, and to the gain-flattening filters used to provide optical amplifiers with uniform spectral response.

2. Description of the Prior Art

Nonuniform signal power levels in WDM communication systems can lead to transmission errors, especially when a signal is transmitted through a chain of optical amplifiers. Optical amplifiers are designed to have a gain that is approximately constant as a function of wavelength, provided the average input power is within specified limits. The gain spectrum of erbium-doped fiber is not intrinsically flat. Typically, static gain-flattening filters (GFFs) are used to flatten the gain spectrum in erbium-doped fiber amplifiers (EDFAs) for a particular average erbium inversion level and erbium-doped fiber length.

The change in gain shape δG(δ)(in dB) with total power-gain change ΔG (in dB) is given by:
δG(λ)=g(λ)ΔG,
where g(λ) is the tilt function. An amplifier with GFF having a flat gain profile (A) for a particular total power gain setting is shown in FIG. 1. As can be seen with reference to that Figure, as the gain setting is changed, the gain profile tilts, favoring shorter (B) or longer wavelengths (C), as the total power gain is decreased or increased, respectively, and changes shape, developing broad spectral features. In order to maintain an approximately flat gain spectrum for different net amplifier gains, a variable optical attenuator (VOA) is typically inserted between two stages of the amplifier, as in FIG. 2. Increasing the VOA loss reduces the net amplifier gain while the erbium inversion level, and hence, gain shape, remains constant.

Unfortunately, as the VOA loss increases (the amplifier gain decreases), the noise figure (NF) of the amplifier degrades. This degradation is especially severe if other loss elements, such as the GFF or a dispersion compensation module (DCM), are included at the same midstage. Moreover, NF degradation is particularly acute in EDFAs that must satisfy high dynamic-range requirements. Increasing the number of gain stages and minimizing the loss between any two stages reduces the NF impact. Also, a single VOA can also be replaced by two VOAs and an additional intervening gain stage. These measures increase cost, complexity, and power consumption, however.

An alternative solution to the VOA and static GFF combination is a dynamic or tunable gain equalizing filter that can produce the transfer functions required to equalize the optical amplifier gain over the required range of gain settings.

FIG. 3 shows a specific example of such a prior art SSP filter 300, a dynamic gain equalizer (DGE), designed to provide arbitrary attenuation on each channel of a multi-wavelength signal for dynamic spectral power equalization. The basic concept of the DGE is disclosed in U.S. Pat. No. 5,745,271, “Attenuation device for wavelength multiplexed optical fiber communications”, and the physical configuration shown is disclosed in U.S. Pat. No. 6,307,657, “Optomechanical platform”. Optical input signals are directed by input fiber 301 through an optical circulator 302 and enter the free-space optical system through input/output fiber 303. Light emitted from input/output fiber 303 is collimated by a first pass through lens 404 to illuminate a reflective diffraction grating 305. The diffraction angle is proportional to the wavelength, so grating 305 acts to separate each wavelength signal by angle. A second pass through lens 304 to a spectrally dispersed plane 306 focuses the diffracted signals where each signal is vertically displaced according to the wavelength.

A micromechanical attenuation device 307 located at the spectrally dispersed plane consists of a column of individually controllable optical attenuators 308. Light which is reflected from the attenuator array retraces the input path as it is recollimated by a third pass through lens 304, diffracting again from grating 305, and finally focused back into the input/output fiber 303. For clarity, the arrows drawn in FIG. 4 indicate the first pass of the light through the optical system from input/output fiber 303 to attenuator array 308. On the return path from attenuator array 308 to input/output fiber 303 the direction is reversed.

Attenuation device 307 may be designed so that each attenuator 308 absorbs a controlled portion of each wavelength signal, as described in U.S. Pat. No. 6,307,657. Other types of attenuation devices can also controllably reduce the amount of light that is coupled into the single mode output fiber 303. FIG. 3 depicts an attenuator device 307 that contains a linear array of tilting micro-mirrors 308 controlled by external electrical connections 309. When one micro-mirror is tilted, the corresponding wavelength signal imaged in a second pass through the optical system is incident on input/output fiber 303 at a controlled angle relative to the fiber face. The efficiency of coupling into the fiber depends on angle of incidence, so a controlled tilt of the micro-mirror controllable reduces the output power of the corresponding wavelength signal coupled back into the input/output fiber 303. Finally, the backwards-propagating output signals pass through the optical circulator 302 and are directed into a separate output fiber 310. Fiber optic components based on variations of this design are commercially available as, for examples, the Dynamic Channel Equalizer sold by LightConnect, Inc., and the “AgileWave” (TM) Dynamic Spectral Equalizer sold by Cidra, Inc. In additon, DGEs may be based on radically different architectures, such as a concatenation of interferometers with dissimilar free-spectral ranges.

Ideally, DGEs generate a loss function with nearly arbitrary shape, limited by their dynamic range and spectral resolution. In addition to amplifier gain flattening, DGEs can correct imbalances in the input spectrum that have accumulated in the preceding network. However, DGE control generally requires measurement of the amplifier output spectrum. The DGE is operated in a closed loop with feedback from a spectrum analyzer. Several iterations may be required for the output spectrum to converge to the desired shape. Feedback can also be used to adjust the DGE in response to long-term drift or variations over temperature. Open-loop operation may also be possible, saving the cost of the spectrum analyzer, for certain types of DGEs, if a sufficiently simple and accurate device model is applicable. However, extensive calibration of the DGE over temperature will still be required.

A DGE should tune from one filter shape to another in such a way that the loss at every wavelength changes monotonically. This property is difficult to achieve in general for certain DGE technologies such as harmonic equalizers, which are based on a series of interferometers, and acousto-optic equalizers, which employ acoustical vibrations to couple light within a certain optical band out of the guided mode of a fiber.

In addition to the added control difficulties, DGEs generally are more costly and add more excess loss than the GFF/VOA combination they would replace. The extra cost comes from the many degrees of freedom required in the DGE and its relatively high spectral resolution. These characteristics allow the DGE to correct accumulated ripple in a system, which may be of nearly arbitrary shape. However, in typical systems with gain-flattened EDFAs, the ripple need not be corrected every span. For a dynamic filter to just flatten EDFA gain, without correcting accumulated ripple, only one degree of freedom is required. As the gain changes, the filter need only tune from one preset filter shape to another. Also, the filter resolution need not exceed the resolution of the amplifier gain shape.

Even a low-resolution DGE requires many degrees of freedom to produce a smooth shape that closely matches the erbium gain shape. The DGE 300 uses bulk optics and a diffraction grating to disperse light onto a discrete array of attenuating elements. The pitch of these elements must be smaller than the monochromatic spot size or else residual ripples will appear in the filter shape. Many attenuators are also required since their registration cannot be pre-aligned to the minima and maxima of the required GFF shapes. The array of attenuators, whether they are MEMS or liquid-crystal devices, has a minimum practical pitch which is on the order of, or larger than, the fiber mode diameter. Thus, these DGEs typically increase the spot size by designing an imaging system with magnification greater than one, resulting in unfolded optical designs with long optical path lengths. Compared to components with shorter folded geometries, these designs are bulkier with more components and higher insertion loss, and it is more difficult and expensive to make such devices insensitive to temperature variations.

Although it would be desirable to provide the functionality of a full-featured DGE and associated spectral monitoring and feedback control in each optical amplifier, the total cost of such a solution is unacceptable in terms of expense, complexity, power dissipation, and physical volume. A need therefore exists for a simple pre-programmable gain equalization filter that is capable of providing a limited number of pre-determined spectral filter functions for a fraction of the cost of a full DGE.

### SUMMARY OF THE INVENTION

We have developed a new method and associated apparatus for dynamic spectral filtering of multi-wavelength fiber optic signals, as used in optical amplification, security or other applications, wherein a set of spectral filter patterns are pre-recorded as a 2-dimensional optical filter with a spatially varying pattern of phase, absorption, or reflectivity. A multi-wavelength input signal carried on an optical fiber is spectrally dispersed using bulk diffractive and imaging optics to illuminate a linear region of the filter, which acts as a spectral variable attenuator by preventing a predetermined portion of the signal from being collected into an optical fiber output.

In prior art dynamic spectral filters, an array of active devices are located at the spectrally dispersed plane. Individual electrical control of the array of devices allows arbitrary attenuation profiles to be imposed upon the multi-wavelength optical signal. However, such general-purpose dynamic spectral equalizers require optical systems that maintain precise alignment to high-resolution modulator arrays, as well as the multi-channel monitoring and feedback control.

According to the present invention, the prior art technique of using a linear array of active modulators is replaced with a static 2-dimensional optical filter, which is in effect a stack of predetermined linear modulation patterns. Instead of changing a single linear filter, the spectrally dispersed signal is steered onto the linear area of the 2-dimensional filter to select one of the pre-recorded patterns. Beam steering of the spectrum may be advantageously accomplished using a single actuator.

In a preferred embodiment, the control is accomplished by tilting a diffraction grating or fold mirror. Tilt in one axis selects which of the linear pre-recorded filters is illuminated. Optional tilt in the orthogonal axis controls the center wavelength of the pre-recorded filter function.

The position of the dispersed spectrum can be monitored by monitoring the position of the single actuator, or through an optical detector located proximate to the spectral filter to directly monitor the position of the dispersed spectrum relative to the filter. The resulting programmable spectral filter is substantially smaller, simpler, and less expensive than prior art dynamic gain equalizers.

### BRIEF DESCRIPTION OF THE DRAWING

FIG. 1 is a graph showing the gain v. wavelength for an amplifier with gain flattening filters;

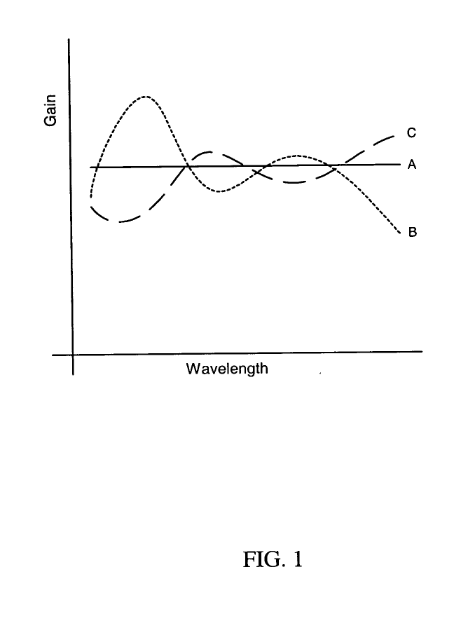

FIG. 2 shows a prior art filter having a variable optical attenuator inserted between the two stages of the amplifier;

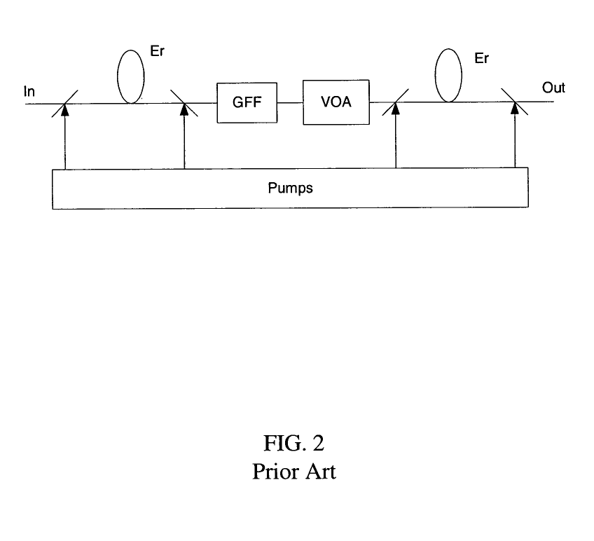

FIG. 3 shows a prior art, switched spectral-plane filter;

FIG. 4 shows an illustrative fiber-optic communications link in an optical communications network according to the present invention;

FIG. 5 shows an illustrative optical amplifier;

FIG. 6 shows an optical system of FIG. 3, modified according to the present invention;

FIG. 7(a)-7(c) shows the effect of laterally shifting spectrum;

FIG. 8 is a graph showing the loss v. wavelength for different filter shapes;

FIG. 9 shows a double-pass spectral filter having an input through a second fiber;

FIG. 10 shows a spectral filter having a roof prism;

FIG. 11(a)-11(d) shows configurations for steering a spectrally dispersed beam;

FIG. 12 shows an optical filter including a spectrum steering system using lateral actuation of the patterned filter;

FIG. 13 shows a position sensitive detector located beneath a spectral filter;

FIG. 14 shows a optical sensing arrangement utilizing photodetectors;

FIG. 15 shows the optical sensing arrangement of FIG. 14, having an additional shield; and

FIG. 16 shows the bands of high and low transmisson or reflectivity between filter stripes.

### DETAILED DESCRIPTION OF THE INVENTION

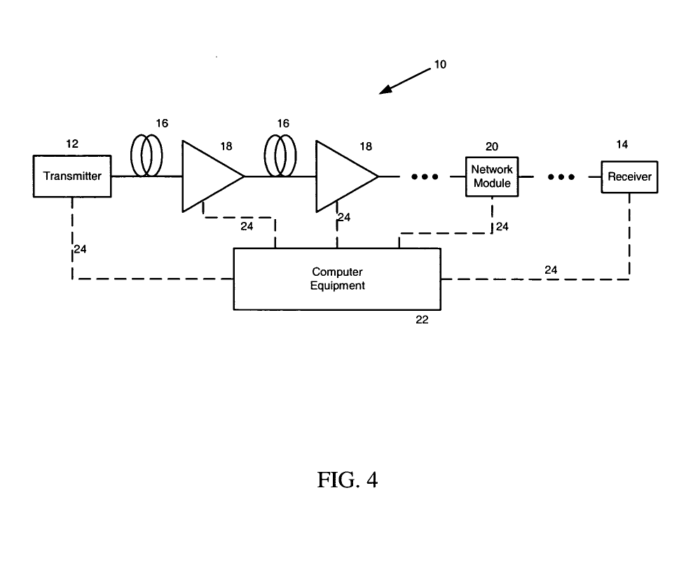

An illustrative fiber-optic communications link in an optical communications network in accordance with the present invention is shown in FIG. 4. As can be readily appreciated by those skilled in the art, a transmitter may transmit information to a receiver over a series of fiber links. Each fiber link may include a span 16 of optical transmission fiber. Fiber spans 16 may be on the order of 40-160 km in length for long-haul networks or may be any other suitable length for use in signal transmission in an optical communications network. Link 10 may be a point-to-point link, part of a fiber ring network, or part of any other suitable network or system known in the art.

With continued reference to FIG. 4, the communications link shown therein may be used to support wavelength division multiplexing arrangements in which multiple communications channels are provided using multiple wavelengths of light. For example, the link shown in FIG. 4 may support a system with 40 channels, each using a different optical carrier wavelength. Optical channels may be modulated at, for example, approximately 10 Gbps (OC-192). The carrier wavelengths that are used may be in the vicinity of 1527-1605 nm. These are merely illustrative system characteristics. If desired, fewer channels may be provided (e.g., one channel), more channels may be provided (e.g., hundreds of channels), signals may be carried on multiple wavelengths, signals may be modulated at slower or faster data rates (e.g., at approximately 2.5 Gbps for OC-48 or at approximately 40 Gbps for OC-768), and different carrier wavelengths may be supported (e.g., individual wavelengths or sets of wavelengths in the range of 1240-1670 nm).

Of course, optical amplifiers 18 may be used to amplify optical signals on link 10. Optical amplifiers 18 may include booster amplifiers, in-line amplifiers, and preamplifiers. Optical amplifiers 18 may be rare-earth-doped fiber amplifiers such as erbium-doped fiber amplifiers, amplifiers that include discrete Raman-pumped coils, amplifiers that include pumps for optically pumping spans of transmission fiber 16 to create optical gain through stimulated Raman scattering, semiconductor optical amplifiers, or any other suitable optical amplifiers.

Link 10 may include optical network equipment such as transmitter 12, receiver 14, and amplifiers 18 and other optical network equipment 20 such as dispersion compensation modules, dynamic filter modules, add/drop multiplexers, optical channel monitor modules, Raman pump modules, optical switches, etc. For clarity, aspects of the present invention will be described primarily in the context of optical network equipment 20 having gain stages and spectral control capabilities. This is, however, merely illustrative. The features of the present invention may be used for any suitable optical network equipment if desired.

Computer equipment 22 may be used to implement a network management system of which a variety are known and used. Computer equipment such as computer equipment 22 may include one or more computers or controllers and may be located at network nodes and one or more network management facilities. As indicated by lines 24, the network management system may communicate with optical amplifiers 18, transmitter 12, receiver 14 and other optical network equipment 20 using suitable communications paths. The communications paths may be based on any suitable optical or electrical paths. For example, communications paths 24 may include service or telemetry channel paths implemented using spans 16, may include wired or wireless communications paths, may involve communications paths formed by slowly modulating the normal data channels on link 10 at small modulation depths, etc. Paths 24 may also be used for direct communications between amplifiers 18 and other optical network equipment.

Additionally, computer equipment 22 may be used to gather spectral and/or aggregate power information from transmitter 12 (e.g., an output power spectrum), receiver 14 (e.g., a received power spectrum), and amplifiers 18 and other equipment 20 (e.g., input and output power spectra and gain spectra).

Finally, computer equipment 22 may use the gathered information from this equipment or other suitable equipment in the network to determine how the operating conditions of amplifiers 18 and the other equipment in link 10 are to be controlled. Operating conditions include the gain and output-power settings of optical amplifiers and the transfer functions of controllable spectral filters. Computer equipment 22 may issue commands to amplifiers 18, transmitters 12, receivers 14, and other equipment 20 that direct this equipment to make appropriate adjustments. The adjustments may be used to optimize the gain or signal spectrum flatness along link 10, may be used to optimize the end-to-end or node-to-node signal-to-noise ratio across the signal band or spectrum, or may be used to implement any other suitable control or optimization functions for link 10.

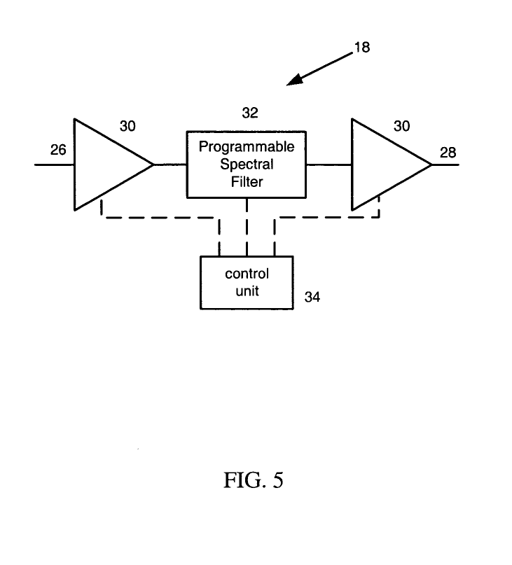

An illustrative optical amplifier 18 is shown in FIG. 5. With reference now to that FIG. 5, optical input signals may be provided to input fiber 26. The optical input signals may be, for example, data traffic being carried on the wavelength-division-multiplexing channels in the signal band of link 10 that is provided to input fiber 26 over a span of fiber 16. Gain stages 30 may be used to provide optical gain for the optical signals. Corresponding amplified output signals may be provided at output fiber 28.

As can be appreciated, programmable spectral filter 32 may be used to modify the gain and output power spectra of amplifier 18. Programmable spectral filter 32 may be referred to as a tunable gain-flattening filter, because programmable spectral filter 32 may be used alone or in combination with a static spectral filter to flatten the gain spectrum of amplifier 18.

In the prior art, and while not specifically shown in this FIG. 5, a dynamic gain equalizer (DGE) would be used in place of programmable spectral filter 32. A DGE has multiple degrees of freedom that can be controlled to approximate almost any filter shape, subject to the limits of the DGE dynamic range and spectral resolution.

In sharp contrast to the prior art, instead of using a general purpose DGE, we now teach the use of a novel inexpensive pre-programmable spectral filter 32 that contains a set of predefined filter shapes. Such a filter can be used in EDFAs to replace the GFF and VOA with a tunable gain-flattening filter (TGFF), providing much of the advantage of a general purpose DGE at a fraction of the cost. An applied electrical signal results in switching or tuning from one filter to another.

For the gain equalization application, the required filter shape can be described as a two-dimensional function of wavelength and amplifier gain. This 2-D function can be recorded as a variable reflectivity on a planar surface. Using such a filter, the TGFF can smoothly transition from one filter shape to another and equalize the amplifier at any arbitrary gain setting. The TGFF has one degree of freedom that is used to tune from one filter shape to another and may also include another degree of freedom that allows the wavelength registration of the filter set to be shifted.

The TGFF uses an optical design similar to many DGEs in that it uses a diffraction grating to disperse the spectrum and an imaging system to image the spectrum onto a surface of variable reflectivity or loss. Reflected light from this surface is remultiplexed by the grating and focused into an output fiber. However, the TGFF utilizes a series of smoothly varying reflection profiles rather than the array of discrete elements of variable reflectivity found in DGEs. Thus, a shorter folded geometry with unity magnification is suitable, resulting in significant cost savings.

In general, various additional components may be positioned at locations along the main fiber path through an amplifier 18. These components may include isolators, taps and photodetectors for optical monitoring (e.g., to measure the gain of amplifier 18), filters (e.g., static spectral filters), wavelength-division-multiplexing couplers, attenuators, dispersion-compensating elements such as dispersion-compensating fiber, gain stages, pumps, pump couplers, optical channel monitors, optical switches, etc. The operation of the components and gain stages 30 and programmable spectral filter 32 may be controlled using control unit 34.

Control unit 34 depicted in FIG. 5 advantageously may be based on any suitable control circuitry and may include one or more microprocessors, microcontrollers, digital signal processors, field-programmable gate arrays or other programmable logic devices, application-specific integrated circuits, digital-to-analog converters, analog-to-digital converters, analog control circuits, or memory devices, etc known to the art. Control unit 34 may include communications circuitry that supports the communications between control unit 34 and computer equipment such as computer equipment 22 of FIG. 5 or other equipment in the network.

Amplifier 18 may be based on an optical network card and may use the communications circuitry to communicate with a controller mounted in a rack in which the card is mounted. The controller may be part of computer equipment 22 or may communicate with computer equipment 22. If desired, amplifier 18 may be implemented as a module that is part of an optical network card. The module may use the communications circuitry in unit 34 to communicate with a controller or other computer equipment 22 or to communicate with additional communications circuitry on the card that in turn supports communications with a controller or other computer equipment 22 in the network. These are merely illustrative communications arrangements that may be used to allow amplifier 18 to communicate with the equipment in the network. Any suitable arrangement may be used if desired.

Amplifier 18 may have taps and optical monitors for tapping a fraction (e.g., 2%) of the light propagating through amplifier 18. The optical monitors may be based on photodetectors or any other suitable optical monitoring arrangement. Transimpedance amplifiers in the monitors or in control unit 34 may be used to convert current signals from the photodetectors in the monitors into voltage signals for processing by analog-to-digital converters or other suitable processing circuitry. The processing circuitry may be located in the monitors or in control unit 34.

Control unit 34 may use input and output power measurements from taps and monitors in amplifier 18 to measure the gain of individual gain stages 30 or aggregates of gain stages 30. These gain measurements may be used in suppressing gain transients. Such gain transients may arise from sudden changes in the number of channels present on link 10 (e.g., due to a network reconfiguration or an accidental fiber cut). When signal and gain fluctuations are detected using the taps and monitors (e.g., input and output taps and monitors associated with each stage), control unit 34 may control the power of the pump light produced by the pumps in gain stages 30 to ensure that the gain or output power of the stages and amplifier 18 remains constant.

With further reference to the amplifier arrangement depicted in FIG. 5, the gain spectrum of amplifier 18 may be controlled by using control unit 34 to adjust programmable spectral filter 32 and the gain of the gain elements (e.g., the optically-pumped fiber) in the gain stages of amplifier 18. If programmable spectral filter 32 is provided as part of a stand-alone programmable spectral filter module or other equipment without gain stages, control unit 34 may be used to adjust programmable spectral filter 32 to produce a desired loss spectrum. For clarity, the present invention will be discussed primarily in the context of equipment that includes one or more gain stages. This is, however, merely illustrative.

By way of additional background, the gain shape of many optical amplifiers G(λ) can be determined from a measurement of its total power gain Gₜₒₜalone, G(λ)=g(λ,Gₜₒₜ). Such amplifiers include semiconductor optical amplifiers (SOAs), Raman amplifiers, rare-earth-doped amplifiers, such as EDFAs, and parametric amplifiers operated at power levels where the gain is unsaturated. Such amplifiers also include amplifiers operating in gain saturation if the communication signals amplified are modulated at speeds significantly in excess of the amplifier gain-relaxation time, as is the case with EDFAs in fiber optic communication systems. Amplifier-gain-stage input and output powers, measured by optical power monitors, may be used as feedback to control the amplifier gain and output power while adjusting the programmable spectral filter to keep the gain spectrum of amplifier 18 flat, or at some other desirable gain shape.

The spectral filter may be designed to keep the gain shape constant as the gain varies. In particular, the filter shape f (λ,a) depends on a control parameter a which can be related to Gₜₒₜ by the control unit such that

$$\frac{\partial }{\partial {G}_{tot}} ( g ( λ , {G}_{tot} ) • f ( λ , a ( {G}_{tot} ) ) ) = 0$$

If the amplifier is operated in a constant-gain mode, the programmable spectral filter will be kept at a constant nominal setting. Monitors internal to the programmable spectral filter may provide feedback to the control unit to maintain the filter at a constant setting. The filter may include a temperature sensor, and the control unit may adjust the filter setting so as to keep the spectral filter shape constant over changes in temperature. This compensation may include adjustment of the wavelength registration of the filter.

As the amplifier input power changes, the control unit 34 will adjust gain stages 30 so as to keep the gain constant. Such adjustments might include changing the output power of diode pump lasers pumping erbium-doped fiber in the gain stages or might include changing the attenuation of variable optical attenuators. These changes may occur on a sufficiently fast time scale so as to suppress undesirable optical transients, or they may occur on a slower time scale.

When the amplifier is operated in constant gain mode the programmable spectral filter will only be adjusted when the control unit 34 receives instruction to change the amplifier gain. These instructions may be transmitted through computer equipment 22 and over communication links 24 or over any other suitable communication link. The amplifier gain and programmable spectral filter setting are optimally adjusted synchronously so that the gain shape is held constant. Optical power monitor readings can be used to monitor the gain and provide feedback during the adjustment. Also, the programmable spectral filter may include internal monitors of its actual spectral setting. These internal monitors may also be used as feedback to the control unit during the adjustment.

The amplifier may be operated in non-constant-gain modes such as constant-output-power mode for which the gain is not kept constant as the input power changes. In these cases, measured changes in amplifier gain will be used to determine how the spectral filter should be adjusted so as to keep the desired gain shape. Advantagiously, the filter may be adjusted synchronously with changes in input power so that the gain shape is always constant. Otherwise, the filter may be adjustment may lag input power changes, eventually returning the amplifier gain to the correct shape.

Spectral filter adjustments may also be used to change the gain shape. For example the spectral filter may be designed to introduce a controllable linear tilt to the gain shape. Such a tilt may be used to compensate for Raman induced tilt in the WDM signal spectrum.

The optical channel power spectrum may be measured at various points in the link. An optical channel monitor could be included within amplifier 18 or external to it in link 10 (FIG. 5). If an external optical channel monitor or other spectrum analyzer is used to gather spectral information for an amplifier 18, the spectral information may be provided to the control unit 34 in that amplifier 18 through computer equipment 22 and over communication links 24 or over any other suitable communications link. This spectral information can be used to optimize the setting of the spectral filter. However, an advantage of the disclosed spectral filter over DGEs is that feedback from an optical channel monitor is not essential to good control.

Besides the gain flattening application, the programmable spectral filter could be used for other applications such as producing a band of filtered ASE of adjustable width and center wavelength.

The programmable spectral filter relies on the principle of spectral steering. The dispersed signal spectrum is imaged onto a two-dimensional surface of variable reflectivity, which serves as a filter. Translating the imaged spectrum in one or two dimensions across the filter's surface varies the spectral shape of the filter.

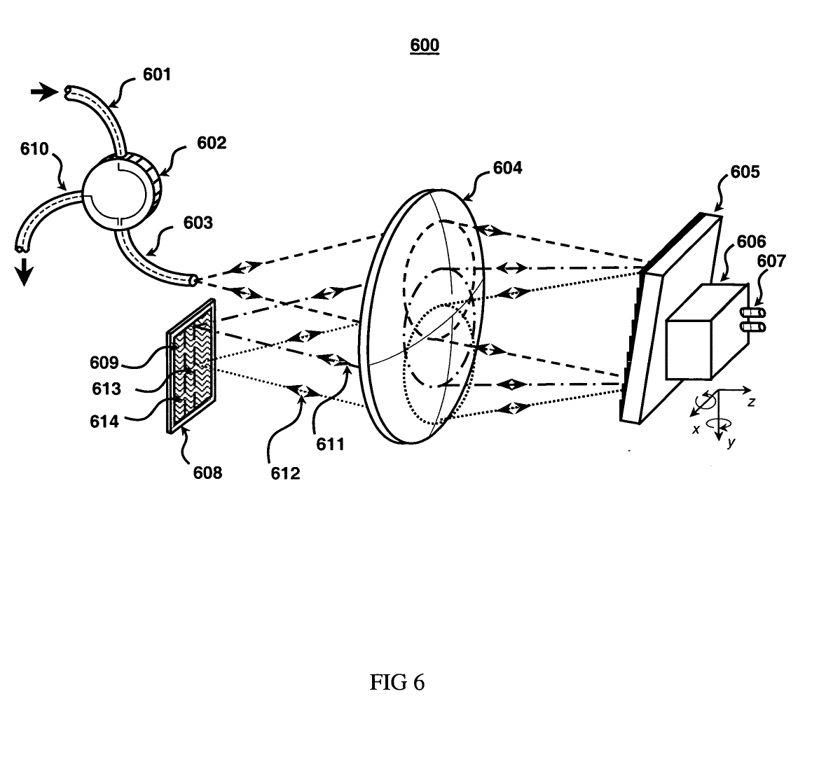

With reference now to FIG. 6, there is shown the basic concept of the invention, and in particular an optical system 600. Specifically, multiple wavelength optical input signals are carried on optical fiber 601 through optical circulator 602 to input/output fiber 603. Light emitted into a free-space volume by input/output fiber 603 is collimated by lens 604 and illuminates a reflective diffraction grating 605 which is mounted on a tip/tilt stage 606 capable of controllably rotating grating 605 about the Y-axis through electrical connections 607. Optionally, grating 605 may rotate about the X-axis, as well, with control though electrical connections 607. Each wavelength signal is diffracted by grating 605 into a distinct angle corresponding to its wavelength; for illustration, two wavelength signals 611 and 612 are drawn using a dashed and dotted lines, respectively. The diffracted signals are focused by a second pass through lens 604 and are imaged onto a spectrally-dispersed image plane 608 to illuminate a permanent spectral-plane optical filter 609, which is patterned so as to selectively reflect, absorb, deflect, or detect, a portion of the spectrally-dispersed multi-wavelength signal.

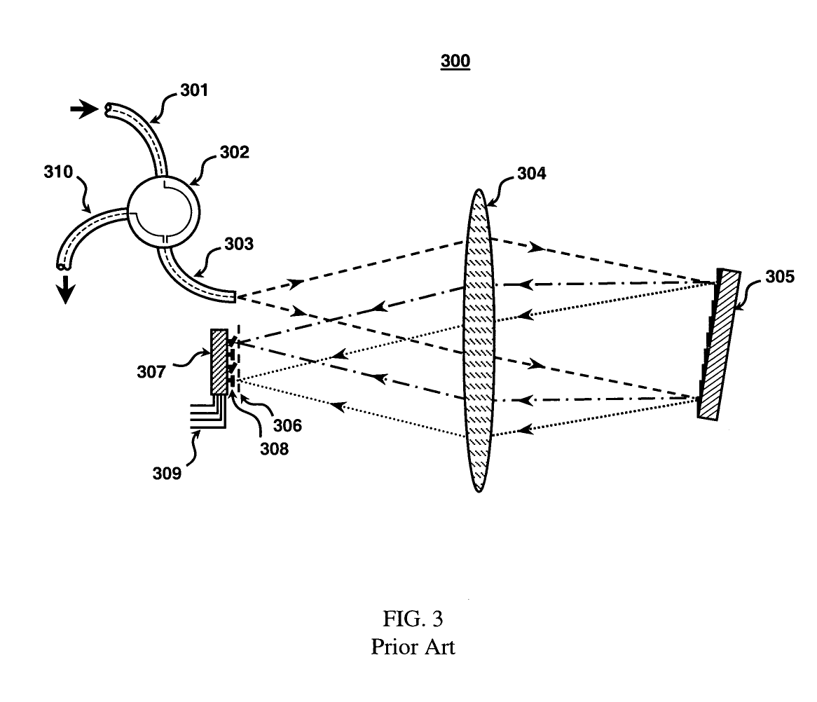

In the prior-art SSP filter shown in FIG. 3, an active device array 307 with electrical controls 309 is positioned in the spectrally-dispersed plane 306. In sharp contrast, the invention of the present application uses no such active device. The permanent spectral-plane structure 309 has no electrical controls to change the effect it has upon the multiwavelength optical signal. Instead of changing the filter, the lateral position of the entire dispersed spectrum is adjusted by electrical connections 307 so as to align the desired wavelength signal with the stationary features of the permanent spectral-plane structure.

With further reference now to FIG. 6, the lateral position of the dispersed spectrum is controlled by tip/tilt stage 606 to rotate grating 605 to the appropriate angle around its X-axis and Y-axis. Tilt of the collimated beam translates into lateral shift of the dispersed spectra at the dispersed spectral image plane 608. Regardless of the lateral shift of the dispersed spectrum, light which is reflected by the spectral-plane filter 609 retraces the input path as it is recollimated by a third pass through lens 604, diffracting again from grating 605, and is focused back into the input/output fiber 603. Each wavelength signal beam is diffracted into an angle corresponding to its wavelength; for illustration, two wavelength signals 611 and 612 are drawn using a dashed and dotted lines, respectively.

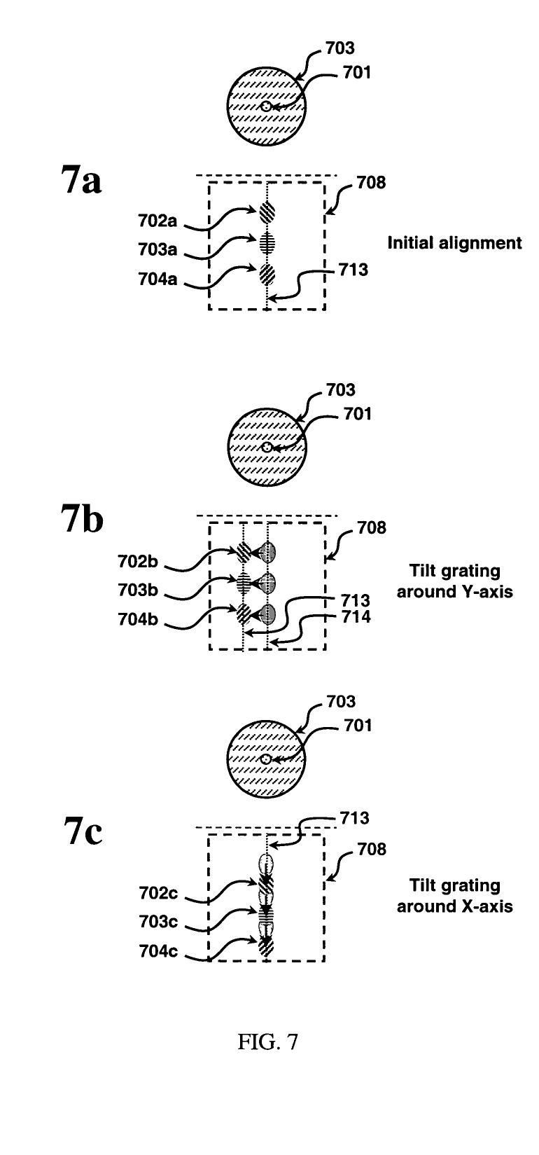

The operation of laterally shifting the spectrum is understood with reference to FIG. 7(a)-7(c), which shows the face of input/output fiber 703 such that the central single mode optical fiber core 701 is visible. The dispersed spectral-plane 708 is positioned below the input/output fiber 703 by appropriate initial alignment of the optical system. However, this placement is merely illustrative. The dispersed spectral plane could be placed to the left, the right, or any other orientation to the input/output fiber. Three wavelength signals 702, 703 and 704 are drawn for illustration, for example corresponding to 1530 nm, 1540 nm, and 1550 nm wavelengths respectively. The three wavelength signals are all emitted from the single mode fiber core 701, where they overlap.

With further reference now to FIG. 6, after making a first pass through the spectral demultiplexing system 600 the three signals are imaged into a column of spots in the spectrally demultiplexed plane 608, where the relative vertical position of each spot is approximately proportional to signal wavelength.

The spot size in the horizontal (x) direction is typically the mode size in the input fiber times the system magnification. If a single lens is used, the magnification is one. The spot size in the vertical (y) direction is the convolution of the mode diameter and the spectral shape of the signal in a single WDM channel. More generally, the intensity profile in the y-direction is the convolution of the input spectrum with the transverse fiber mode profile. With continued reference now to FIG. 7, the spot separation is given by fDΔλ where f is the lens 604 focal length, D is the angular dispersion of the grating 605 and Δλ is the wavelength separation of the WDM channels. For the GFF/VOA-replacement application, it may not be necessary for individual WDM channels to be resolved into non-overlapping spots.

Turning our attention simultaneously to FIG. 7, in the initial alignment state of the system shown in FIG. 7(a), the column of spots 702a, 703a and 704a is centered in the spectrally demultiplexed plane 708. The filter 609 of FIG. 6, has a varied characteristic along line 713 such that signals 702, 703, and 704 may couple back into input/output fiber 603 of FIG. 6 with varied amounts of attenuation. For example, the varied characteristic might be the reflectivity of the filter 609 of FIG. 6 or it might a deflection angle resulting from a diffraction grating written onto the filter 609.

For simplicity we will assume that the characteristic is specular reflection. A variable reflectivity may be achieved in any of a number of ways. The filter may comprise an absorbent or transparent substrate, such as glass, with a coating of variable reflectivity. The reflective coating may be a metal such as gold or may consist of a single- or multi-layer dielectric. The reflectivity of a metal can be varied by a change in its thickness. Alternatively, the metal may be of one thickness but stippled or patterned in a dot matrix so that the average density of the dots over the imaged monochromatic spot determine the reflectivity at a given wavelength. Alternatively, a reflective substrate (mirror), either metallic or dielectric, may be coated with a material of variable absorptivity. The diffraction into the Oth order of a one- or two-dimensional phase grating may be varied by modulating either the phase or duty cycle of the features.

In order to perform gain flattening, the variation in reflectivity along line 713 should preferably be a continuous function corresponding to the inverse of the amplifier gain spectrum. Other functions could be chosen, for example to compensate for wavelength-dependent transmittance of the line 713. Stimulated Raman scattering is one cause of such wavelength dependence.

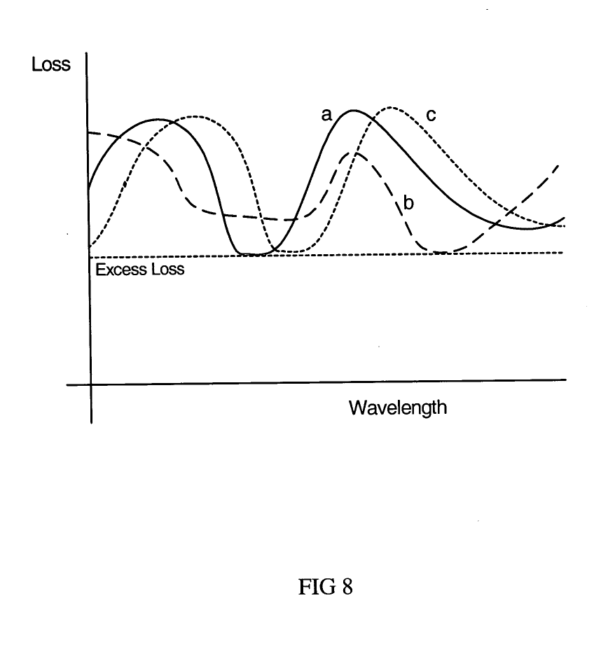

With continued simultaneous reference to FIGS. 6 and 7, and in particular FIG. 7(b), there is shown the result when the reflective grating 605 is rotated about the Y-axis. The spots have the same position relative to each other, but each spot is laterally shifted to new positions 702b, 703b and 704b along line 714. The result is the selection of a new filter shape as shown in FIG. 8(a)-FIG. 8(b).

With reference now to that FIG. 8, filter shapes represented by lines a and b of the graph depicted in that FIG. 8 may correspond to the desired GFF shapes for two different optical amplifier gain settings. The system has an excess loss that is the loss still present when the reflectivity of the filter is maximized. Note that filter shapes represented by lines a and b are both designed to have loss minima equal to the excess loss of the spectral dispersing and recollecting optics. If both filters represented by lines a and b are GFFs for an EDFA, minimizing the excess loss of each minimizes the amplifier NF for both gain settings.

Returning now to FIG. 7(b) and with simultaneous reference to FIG. 6, there it shows the result when the reflective grating 605 is rotated about the X-axis. The spots have the same position relative to each other, but each spot is vertically shifted to new positions 702c, 703c and 704c along line 713. The result is a shifting of the center wavelength of the filter as shown in FIG. 8(a)-8(c). For the amplifier equalization application, tuning the filter center wavelength is typically not necessary during amplifier operation. Thus, this degree of freedom need not be included in the spectral filter design. However, it may be used to compensate for undesired shifts in the wavelength registration that might occur due to changes in the spectral filter's physical properties as a function of temperature or aging. The device temperature dependence could be compensated for using calibration data in a look-up table. Active monitoring of the spectrum output could also be used to provide feedback.

The actuations described above may be termed “spectrum steering”, as the input spectrum is steered to the required position on the permanent spectral-plane structure, as opposed to changing the filter itself. Therefore this type of filter can be called a spectrum steering filter (SSF).

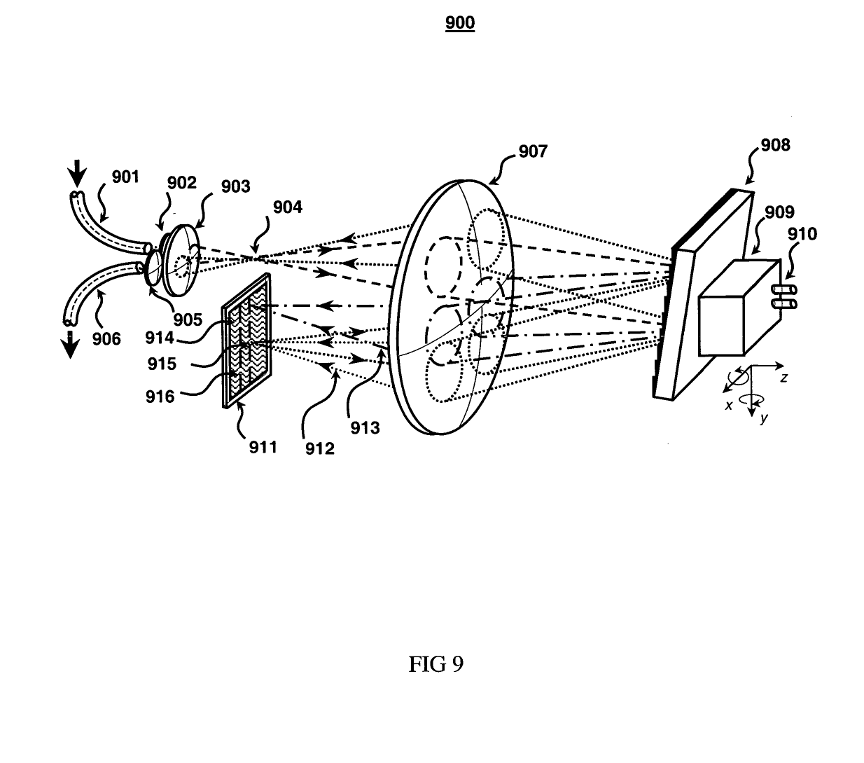

Optical circulators increase system cost and insertion loss. A second embodiment of an optical filter 900 having an optical input and output and no circulator is shown in FIG. 9. With reference now to that FIG. 9, a multi-wavelength input signal carried on input fiber 901 is collimated by micro-optic lens 902 and then illuminate micro-optic lens 903 off-center from the optical axis so that the input signal is focused at an angle to focal point 904, which forms the input point for the spectrally dispersive imaging system.

Input light from focal point 904 is collimated by lens 907 and illuminates planar reflective diffraction grating 908 mounted on tip/tilt stage 909 capable of rotating grating 908 about its X-axis or Y-axis. Each wavelength signal beam is diffracted into an angle corresponding to its wavelength; for illustration, two wavelength signals 913 and 914 are drawn using a dashed and dotted lines, respectively. All signals are focused by a second pass through lens 907 and are imaged onto a permanent spectral-plane structure 911 with patterned reflectivity. The spectral signals are reflected at the dispersed spectral-plane and retrace their path through the optical system to be collected into a single image spot. In filter 900, the image spot is at point 904. Output signals pass through point 904 at a complementary angle to the input signal and illuminate micro-optic lens 903 off-center from the optical axis so that the emerging collimated signal illuminates output micro-optic lens 905 and is focused into output fiber 906.

Alternative versions of the designs shown in FIG. 6 and FIG. 9 are possible and contemplated. In an unfolded geometry, for example, the beam deflected by the grating would pass through a separate lens of potentially different focal length. The filter would then reside in a different image plane. This configuration allows greater degrees of freedom for minimizing aberrations, but is bulkier and requires more components. As is well known to those skilled in the art, 4f imaging can also be accomplished with curved reflectors in place of lenses. It is also possible to combine the lens and grating function into a single element using a curved ruled or holographic grating, which provides optical power as well as diffraction.

Both of the designs shown in FIG. 6 and FIG. 9 incorporate structures that direct light from an input fiber, to the filter in the spectrally demultiplexed plane where it is reflected, and to a separate output fiber. In FIG. 6, an optical circulator is used. In FIG. 9, a microlens array is used to transform parallel beams of light entering or exiting parallel fibers into beams that intersect at the demultiplexed plane.

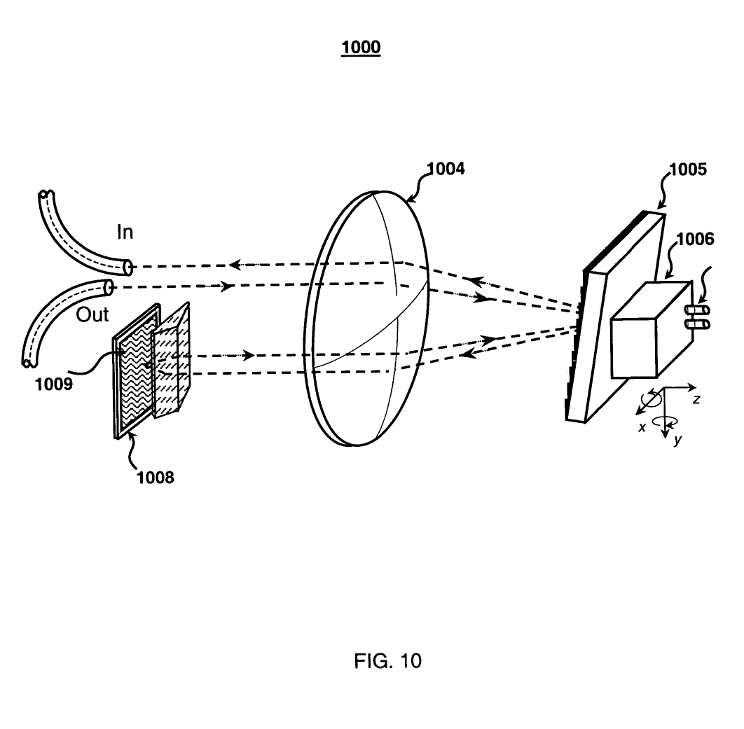

Another option is to place an optical element such as a roof prism near the demultiplexed plane that changes the relative angle of the input and output beam from parallel to converging as shown in FIG. 10. Each beam has a virtual image on the demultiplexed plane, and the two virtual images are separated by an amount equal to the fiber separation.

Other design refinements are possible using a variety of optical design techniques. For example, polarization diversity or polarization averaging may be included to reduce the polarization-dependent loss of the system. Polarization averaging relies on a birefringent quarter-wave plate positioned between the transform lens and the grating. A system with polarization diversity may readily incorporate an internal circulator with the addition of a few optical elements at the device input such as birefringent polarization walk-off crystals, wave plates, and Faraday rotators. In all designs, the fiber ends and the filter must lie within the imaging system's field-of-view in order to minimize aberrations and associated insertion loss.

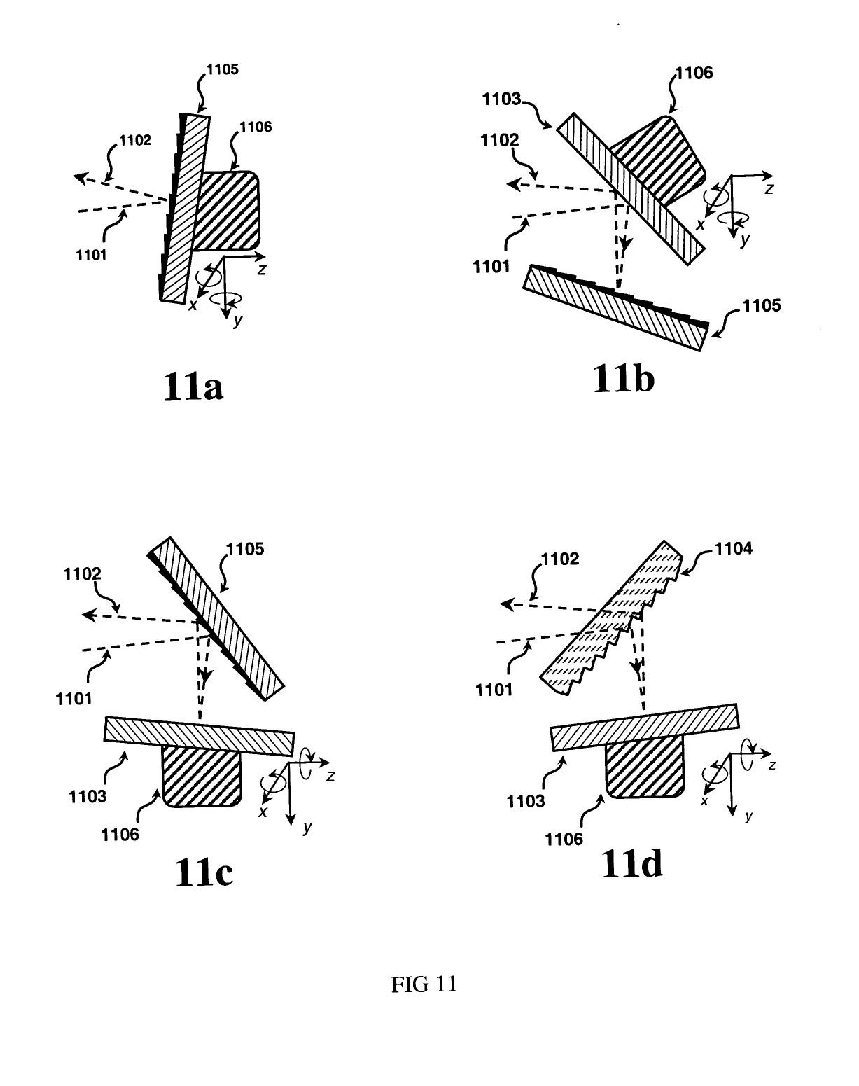

FIG. 11 shows several exemplary means for applying tilt to the reflected multi-wavelength signal. Referring now to FIG. 11(a), an illustrative single wavelength input beam 1101 is incident on reflective diffraction grating 1105 is mounted directly on 2-axis tip/tilt mount 1106 used to control the direction of the diffracted output signal 1102.

In FIG. 11(b), input beam 1101 is reflected from a first-surface mirror 1103 mounted on tip/tilt stage 1106 and to illuminate reflective diffraction grating 1105, now stationary, such that the diffracted output signal 1102 reflects again from mirror 1103. As in FIG. 11(a), the tip/tilt stage controls the direction of the diffracted output, but in this configuration, and as can be readily appreciated, the output angle is approximately twice as sensitive to tip/tilt stage angle as in FIG. 11(a).

In FIG. 11(c), the input signal 1101 is diffracted from stationary reflective diffraction grating 1105 and illuminates first surface mirror 1103 mounted on tip/tilt stage 1106. Mirror 1103 is oriented so that the reflected signal is incident on reflective diffraction grating 1105 where it diffracts a second time. This configuration provides approximately twice the change in output angle as a function of input wavelength (spectral dispersion) as those configurations shown in FIG. 11(a) and FIG. 11(b).

In FIG. 11(d), input signal 1101 is diffracted in passing through transmissive diffraction grating 1104 then is incident upon first surface mirror 1103 mounted on tip/tilt stage 1106. The reflected signal is diffracted again by a second pass through transmissive grating 1104 to output 1102. In configurations shown in FIGS. 11(c) and 11(d), where the scanned surface is the second reflective surface, rotation of the tip/tilt stage about the z axis controls lateral position of the imaged dispersed signals 702, 703 and 704 shown in FIG. 7.

In each of the systems shown in FIG. 11, the active moving element can be actuated by any of a number of mechanisms known in the art of optical scanning including, for examples, stepper motor driven screws, piezoelectric direct or screw drive actuators, torsional galvanometric actuators, thermal expansion actuation, and direct manual actuators. Other means known in the art for optical beamsteering include micro-electro-mechanical systems (MEMS) actuators such as the devices used for constructing large port-count optical crossconnects. Such crossconnects typically involve two-dimensional arrays of dozens or hundreds of 2-axis gimbal-mounted beamsteering mirrors, where electromagnetic or electrostatic actuators control each mirror. In the current invention only a single, relatively large diameter, tilt-mirror is required but the same fabrication and drive techniques are applicable.

Although all of the system embodiments described so far use reflective optical system geometries based on the reflective beam steering configurations shown in FIG. 11, it is also possible to construct an optically equivalent system using a transmissive beam steering means. Such means can include, for example, use of rotating prism pairs, liquid crystal beam deflectors and electro-optic beam deflectors.

All of the systems described so far use angular tilt of the collimated signal beams to introduce a lateral shift at the spectrally dispersed image plane. The same concepts for optical filtering using a permanent spectral-plane structure can be also implemented using a physical translation of either the input fiber or the permanent spectral-plane structure. A variety of physical translation actuators can be used to control lateral position, including for example threaded screws driven by stepper motors, by direct current motors, by piezo-electric actuators, or driven manually.

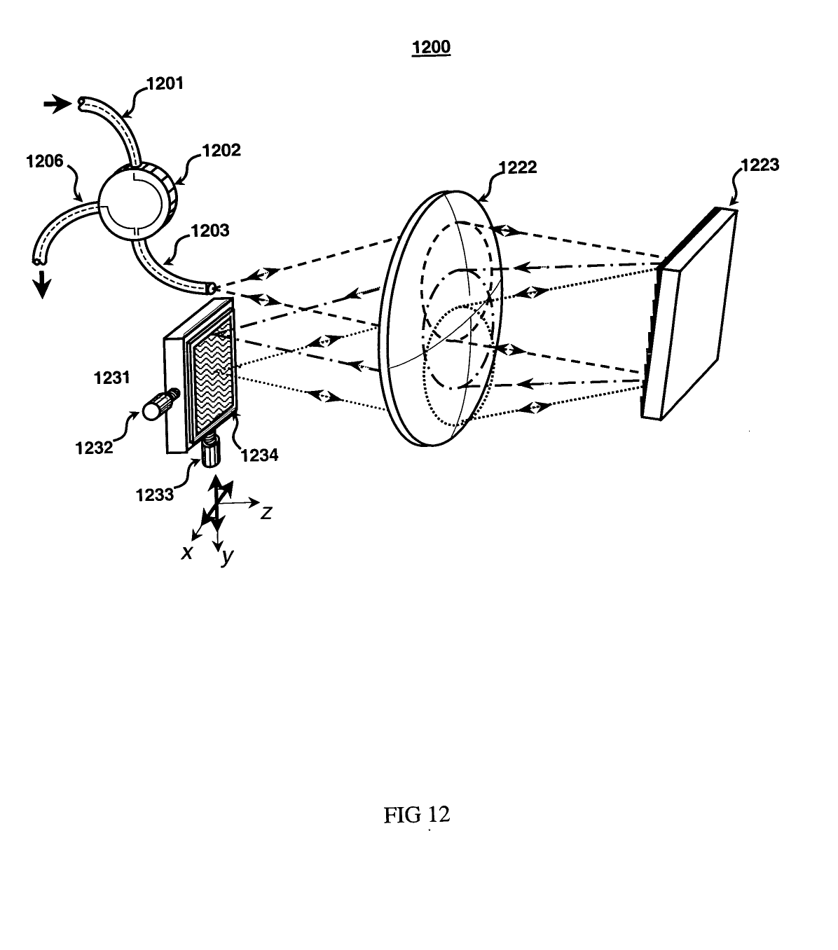

As an example, FIG. 12 shows an optical filter 1200 in which, an input signal carried on fiber 1201 passes through optical circulator 1202 to input/output fiber 1203, then is collimated by lens 1222 and illuminates reflective diffraction grating 1223 that is fixed in-position. Each wavelength signal beam is diffracted into an angle corresponding to its wavelength then focused by a second pass through lens 1222 and imaged onto a permanent spectral-plane structure 1234 that reflects the filtered signal back through the optical system, into input/output fiber 1203, through optical circulator 1202 into separate output fiber 1206.

Instead of using a tip/tilt stage for position control, however, spectral plane structure 1234 is mounted on two-axis translation stage 1231 so that its lateral position can be directly controlled by horizontal (X-axis) and vertical (Y-axis) actuators 1232 and 1233, respectively.

In FIG. 12, the two lateral position actuators shown are manual screws. Actuator 1233 then controls the center wavelength of the transmitted signal, and actuator 1232 controls the wavelength bandwidth of the transmitted signal. Equivalent lateral-shifting embodiments can be constructed for each of the systems described herein.

The ability to monitor the spectral setting of the filter simplifies its control and obviates the need for external optical spectrum analyzers or optical channel monitors. Several layers of monitoring are desirable. First the tip/tilt actuator should include sensors that monitor the position of the mirror or grating (whichever the movable element). These sensors can be used to provide feedback to the electronic drive circuit in order to facilitate smooth and rapid tuning and to adjust drive voltages as necessary to maintain a constant filter setting.

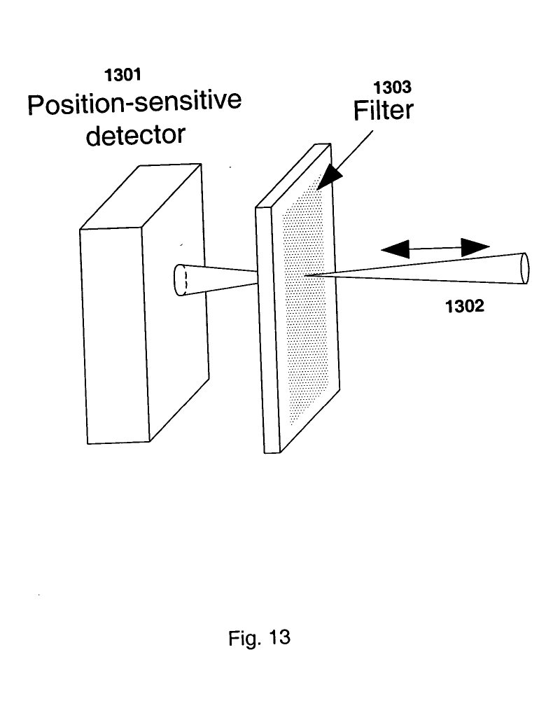

It may be desirable to include optical sensing of the filter setting since the position of the beam on the filter could drift due to temperature changes or aging, even as the grating is held in a constant position. The vertical position of the narrow stripe can be registered using a single-axis position sensitive detector (PSD) 1301 located immediately under the spectral filter shown in FIG. 13.

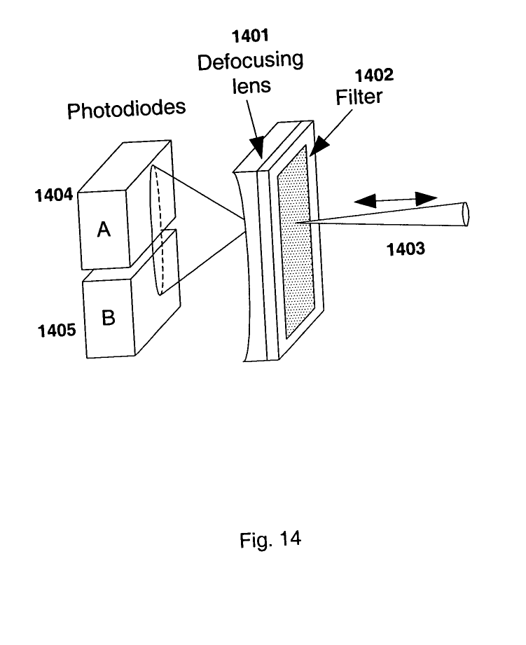

In a PSD, an electrical output responds to the centroid of intensity illuminating the detector. Another mechanism of optical sensing is shown in FIG. 14. With reference now to that FIG. 14, there is shown a filter 1402 that is a transparent plate with a partially reflective coating on either its top or bottom surface. A cylindrical defocusing lens 1401 that spreads the transmitted light in the x direction follows the filter 1402. A pair of photodetectors 1404, 1405 follows this lens 1401 in the optical path. The focal length of the lens and the separation between the filter and the lens and the lens and the photodiodes are all chosen so that light is incident on both diodes for all spectral filter settings. Moreover, as the beam incident on the filter is translated from the bottom extreme of its range to the top extreme, the power detected by diode A should increase monotonically while that on B should decrease monotonically. Thus, the x position of the beam is uniquely measured by the ratio of the photodiode currents, independent of the input spectrum or power or the filter shape.

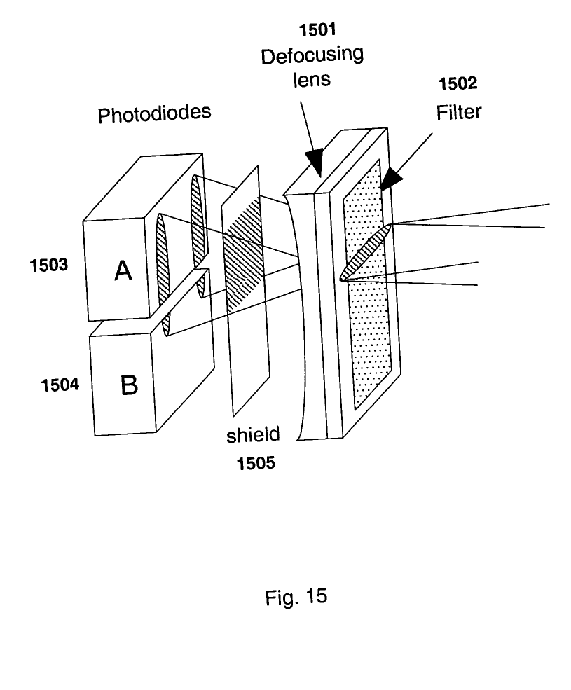

If the partially reflective surface is stippled, as in a half-toned gray-scale image, then the light passing through will diffract. The angles of diffraction will depend on the size and density of the metal dots, which vary across the surface of the filter. Thus, the photodiode currents might become a function of the input spectrum and not a unique measure of filter setting. A modified design eliminates this potential problem. In this design part of the optical spectrum passes through a non-reflective part of the filter. Thus, it is effectively removed from the optical signal. For example, every EDFA gain stage produces amplified spontaneous emission (ASE) that extends beyond the edges of the WDM spectrum. This light may pass through non-reflective (clear) portions of the filter without any diffraction (FIG. 15).

As shown in that FIG. 15, a shield 1505 blocks the transmitted (and diffracted) WDM signal light from striking photodiodes 1503, 1504. And while the arrangement shown in that FIG. 15 has the shield 1505 positioned after the lens 1501 in the optical pathway, it could instead be placed before the lens or deposited directly onto the back of a filter substrate 1502. Alternatively, two or more photodiodes could be sized and positioned so that only ASE strikes them, without the need for a shield.

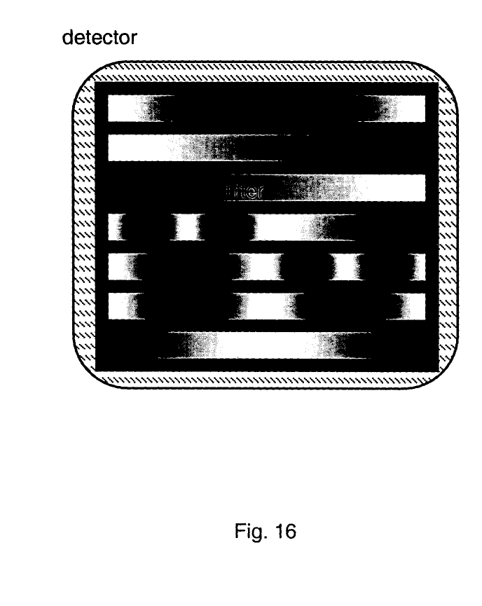

If the filter has discrete shapes encoded as stripes across its surface, or if the detector has an additional cover filter of dark stripes across it's surface, then y positioning can be determined using only one photodetector. The spectral filter (or photodetector cover filter) has bands of very high or very low transmission or reflectivity between each filter stripe, as shown in FIG. 16. Movement of the diffracted beam vertically from one filter to another is then registered as nulls or peaks in the detected photocurrent. By counting the power oscillations, the change in filter setting is determined. The beam can be locked onto a filter stripe by dithering the beam position vertically and minimizing or maximizing the detected power (depending on whether the stripes are dark or light).

1. A optical amplification method comprising the steps of:
receiving an optical signal for amplification;
selecting, a pre-programmed filter from a plurality of such filters;
applying, the selected filter to the received signal; and
amplifying the filtered signal.

2. The amplification method according to claim 1 further comprising the step of:
collecting control system input sufficient to select filtering characteristics.

3. The amplification method according to claim 1 wherein the pre-programmed filter is one of a set of predetermined filter profiles wherein each one of the set has an arbitrary shape.

4. A optical amplification method comprising the steps of:
receiving an optical signal for amplification;
amplifying the received signal;
selecting, a pre-programmed filter from a plurality of such filters; and
applying the amplified signal to the selected filter.

5. The amplification method according to claim 5 further comprising the step of:
amplifying the filtered signal.

6. The amplification method according to claim 5 further comprising the step of:
collecting control system input sufficient to select filtering characteristics.

7. The amplification method according to claim 5 wherein the pre-programmed filter is one of a set of predetermined filter profiles wherein each one of the set is an arbitrary shape.

8. A method of controlling/maintaining gain in an optical amplifier comprising the steps of:
collecting, control system input pertaining to a received optical signal, sufficient to select a pre-programmed filter from a plurality of such filters;
selecting, the pre-programmed filter; and
applying the signal to the filter;
such that the gain of the optical amplifier substantially achieves a desired profile as a function of optical signal wavelength.

9. The method according to claim 8 wherein the selected filter is an arbitrary, pre-determined one wherein the pre-programmed filter is one of a set of predetermined filter profiles wherein each one of the set has an arbitrary shape.

10. The method according to claim 9 further comprising the step of:
adjusting dynamically the spectral tilt of the gain profile of optical amplifier.

11. The method according to claim 10 wherein the dynamic adjusting is performed as a function of channel loading.

12. The method according to claim 11 wherein the dynamic adjusting is performed as function of input power to the amplifier.

13. The method according to claim 8 in which the control system information pertaining to the optical signal includes a measure of the gain at one or more erbium stages of the amplifier.

14. The method according to claim 8 further comprising the step of:
blocking of one or more wavelengths by the optical amplifier as a function of the input to the control system.

15. An optical filter comprising:
a pre-programmed fixed optical spatial filter;
an optical system for dispersing an input spectrum on to said filter wherein said optical system includes:
a lateral position control system for controlling the lateral position of the dispersed spectrum on the pre-programmed fixed optical spatial filter positioned at the demultiplexed spectral plane; and
an optical system for collecting the dispersed, filtered spectrum and directing it as an output spectrum.

16. The optical filter according to claim 15 wherein said pre-programmed fixed optical spatial filter is a 2-D optical phase filter.

17. The optical filter according to claim 15 wherein said pre-programmed fixed optical spatial filter is an amplitude filter.

18. The optical filter according to claim 15 wherein said pre-programmed fixed optical spatial filter is a reflection filter.

19. The optical filter according to claim 15 wherein said lateral position control system includes a tilting reflective surface to control the lateral position of the dispersed spectrum.

20. The optical filter according to claim 15 wherein said lateral position control system includes a transmissive linear phase controller to control the lateral position of the dispersed spectrum.

21. The optical filter according to claim 15 including an input fiber lateral shifter for controlling the position of the dispersed spectrum.

22. The optical filter according to claim 15 including a filter shifter for controlling the position of the dispersed spectrum.

23. The optical filter according to claim 15 further comprising a detector for detecting the position of the dispersed spectrum on the optical filter.

24. An optical amplifier comprising:
means for receiving an optical signal;
means for selecting a pre-programmed filter from a plurality of such filters;
means for applying the selected filter to the optical signal; and
means for amplifying the optical signal.

25. The optical amplifier according to claim 24 further comprising:
means for collecting control system information sufficient to select the pre-programmed filter.

26. The optical filter according to claim 25 wherein the pre-programmed filter is one of a set of predetermined filter profiles wherein each one of the set has an arbitrary shape.
